(19) United States
(12) Patent Application Publication
(10) Pub. No.: US 2017/0284360 A1
(43) Pub. Date: Oct. 5, 2017

(54) HYDROELECTRIC POWER GENERATOR SYSTEM AND METHOD

(71) Applicant: Frederick J. Jessamy, Miramar, FL (US)

(72) Inventor: Frederick J. Jessamy, Miramar, FL (US)

(21) Appl. No.: 15/493,607

(22) Filed: Apr. 21, 2017

Related U.S. Application Data
(63) Continuation-in-part of application No. 14/779,528, filed on Sep. 23, 2015, now abandoned.
(60) Provisional application No. 62/058,430, filed on Oct. 1, 2014.

(51) Int. Cl. F03B 13/22; F03B 13/08

(52) U.S. Cl. CPC F03B 13/22; F03B 13/08; F03B 7/00

(57) ABSTRACT

The present invention is a hydroelectric power generating system having a siphon component, a generator component, and an electronics and control component, which produces an inflow of water caused by a vacuum initially created within the system and further aided by hydrostatic pressure. The inflow is directed to a ramp where it drives a water turbine located within the respective electrical generating system to produce electrical power.

### CROSS-REFERENCE TO RELATED APPLICATIONS

This non-provisional patent application is a continuation-in-part of, and claims the benefit of, the currently pending U.S. Non-Provisional patent application Ser. No. 14/779,528, filed on 23 Sep. 2015, which is a National Stage Entry of PCT/US15/41045 filed on 19 Jul. 2015, currently pending, which claims priority from Provisional Application No. 62/058,430, filed on 1 Oct. 2014, currently expired, all of which are incorporated by reference as if fully set forth herein.

### STATEMENT REGARDING FEDERALLY SPONSORED RESEARCH OR DEVELOPMENT

Not applicable.

### FIELD OF THE INVENTION

The present disclosure generally relates to an electrical power generating system. More particularly, the present disclosure relates to a hydroelectric power generating system that takes advantage of pressure differentials in deep water to facilitate a water flow convertible to electrical energy.

### BACKGROUND

Hydroelectric power generating systems are known in the art. Conventional systems utilize a natural geographical location, such as a valley, or the like, and place man-made structures such as a man-made dam across a flowing channel in a natural setting to create a reservoir upstream of the dam. The water is then forced to flow through one or more gates that are interconnected to power generating turbines in the powerhouse located within the dam to create electrical power.

Currently, in order to harness hydropower electricity a massive inflow of water created by a drop, or impact is used, to drive water turbines. These turbines gain momentum as a continuous inflow of water hits them. However, in order for this approach to function properly locations must be carefully chosen. In some instances, construction is difficult to perform due to terrain. Additionally, variations in water inflow rates created by seasonal changes and droughts can deter electrical production, resulting in financial losses and electrical scarcity. This results in limitations and restrictions as to where hydropower electric stations can be constructed.

Current hydropower electrical systems are located in regions where water flow is driven by gravity. Without gravity to produce water flow, these systems wouldn't have the capability to produce electrical energy. Accordingly, terrain gradients are another limiting factor where a hydropower electrical system can be introduced.

Accordingly, in order to overcome the above mentioned drawbacks, disadvantages and limitations of existing hydroelectric power generating systems, and the growing need for electrical energy in an increasingly growing society, there has never been an ever-increasing demand for a new, efficient, ocean driven hydropower electrical system. It would be highly desirable to provide such a system that integrates all of the necessary functions heretofore performed, without having any of the prior aforementioned drawbacks.

It would, therefore, be desirable to have an apparatus, system, and related method that can generate electricity from a water flow that is not driven by terrain gradients. Therefore, there currently exists a need in the art for an apparatus, system and related method that can generate electricity from a water flow, where this water flow is facilitated by the naturally occurring pressure differentials found in deep water, such as in the oceans.

While certain aspects of conventional technologies have been discussed to facilitate disclosure of the invention, Applicants in no way disclaim these technical aspects, and it is contemplated that the claimed invention may encompass one or more of the conventional technical aspects discussed herein.

In this specification, where a document, act, or item of knowledge is referred to or discussed, this reference or discussion is not an admission that the document, act, or item of knowledge or any combination thereof was, at the priority date, publicly available, known to the public, part of common general knowledge, or otherwise constitutes prior art under the applicable statutory provisions; or is known to be relevant to an attempt to solve any problem with which this specification is concerned.

### SUMMARY

The present disclosure is generally directed to a hydroelectric power generating system, which takes advantage of pressure differentials between the surface and floor of a body of water, such as the ocean. The overall system is comprised, generally, of a siphoning component, a generator component, and an electronics and control component. The siphoning component utilizes a sealable pipe with one end submerged in the water and the other end above the water surface. The siphoning component further utilizes a vacuum pump to draw the air out of the pipe. This vacuum pump, along with, and aided by, the hydrostatic pressure exerted by the water at depth, causes the pipe to fill with water. A one or more directional flow valve prevents backflow and ensures that water flows out of the pipe and onto the generator component. The generator component includes a sluice or ramp structure, having a higher portion and a lower portion, that floats or otherwise remains above the surface of the water with the pipe outlet flow directed at the higher portion. The water then flows down the sluice and past a one or more turbine generator. The action of the water turning the turbines connected to electricity generators, generates power. This electrical energy may then be stored or transferred to another location through means as may be known in the art, such as batteries or power transmission cables. The electronics and control component provides power to the vacuum pump and is communicative with one or more flow sensors. As the flow sensors measure and detect the flow rate of the water exiting the pipe, the electronics and control component selectively opens and closes the pipe covers and powers the vacuum pump to maintain a preselected flow rate.

These and other features, aspects, and advantages of the invention will be further understood and appreciated by those skilled in the art by reference to the following written specification, claims, and appended drawings.

### BRIEF DESCRIPTION OF THE DRAWINGS

These and other features, aspects, and advantages of the present invention will become better understood with regard to the following description, appended claims, and accompanying drawings where:

FIG. 1 presents a side view of an exemplary hydroelectric power generating system according to an embodiment of the present invention;

FIG. 2 presents a side view of an exemplary hydroelectric power generating system, wherein the system is illustrated showing a water flow driving the water turbines, according to an embodiment of the present invention;

FIG. 3 presents a cross-sectional view of a portion of the invention showing the ramp, water turbine, and generators according to an embodiment of the present invention; and

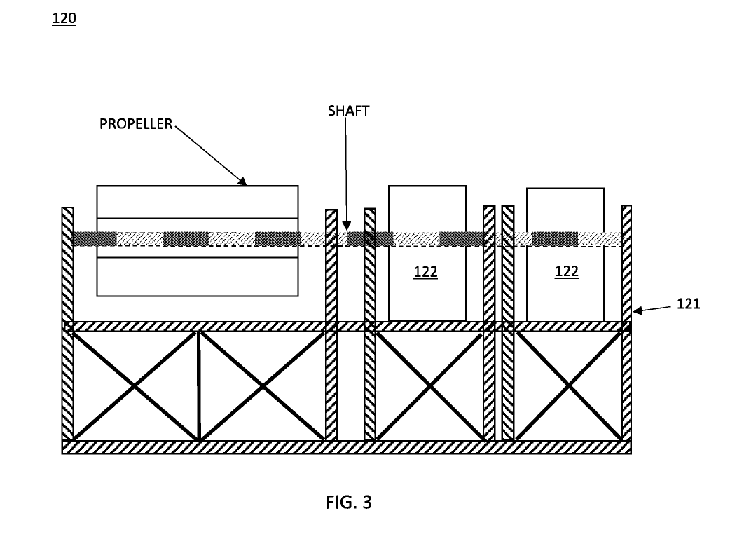

Like reference numerals refer to like parts throughout the several views of the drawings.

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DESCRIPTION

In the Summary above and in the Description, and the Claims below, and in the accompanying Drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm.

Any element in a claim that does not explicitly state “means for” performing a specified function, or “step for” performing a specific function, is not to be interpreted as a “means” or “step” clause as specified in 35 U.S.C. §112, ¶ 6. In particular, the use of “step of” in the claims herein is not intended to invoke the provisions of 35 U.S.C. §112, ¶ 6.

While the specification concludes with claims defining the features of embodiments of the invention that are regarded as novel, it is believed that the invention will be better understood from a consideration of the following description in conjunction with the figures, in which like reference numerals are carried forward.

Apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

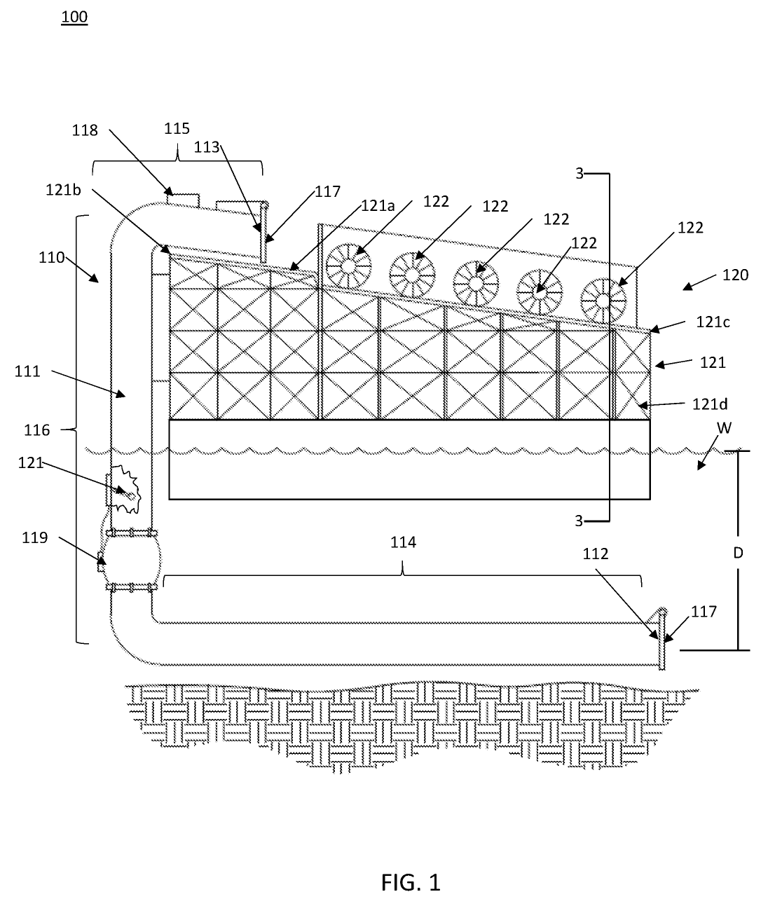

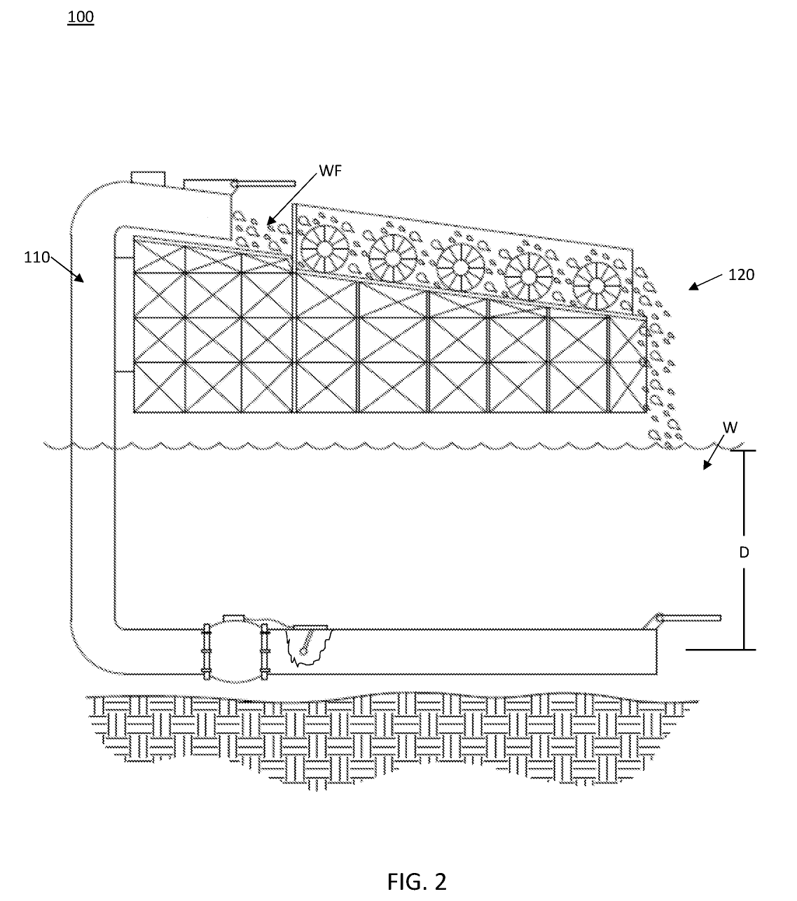

Referring now to the figures in general, and FIG. 1 in particular, we discuss a preferred embodiment of the present invention. A hydroelectric power generator system 100 includes a siphoning component 110, a generator component 120, and an electronics and control component 130 (not illustrated in the figure). In the preferred embodiment, the system operates in a body of water, such as the ocean, W, where the siphoning component 110 draws water up from a predetermined depth D and deposits the water WF onto the generator component 120, whereby, as illustrated in FIG. 2, the deposited water WF flows in communication with the generator component 120, thereby generating electrical energy. This electrical energy may then be stored or transmitted as desired according to methods or means as is known in the art. The water flow rate is monitored and regulated by the electronics and control component 130.

The Siphoning Component 110

The siphoning component 110 of the system is comprised of a pipe 111 with an inlet 112 and an outlet. The pipe 111, as shown in FIG. 1, is configured with a substantially horizontal portion 114 at the inlet 112, a downward angled outlet portion 115, and a vertical portion 116 extending between the horizontal portion 114 and the downward angled outlet portion 115. Each of the inlet 112 and outlet 113 are further comprised of covers 117. Each of these covers 117 is sealably communicative with their corresponding opening (either the respective inlet or outlet). Each cover is configured with opening and closing mechanism as may be known in the art, such as, but not limited to, electric motors, servos, pneumatic mechanism, or hydraulic mechanisms. These opening and closing mechanisms are operatively communicative with the electronics and control component and are actuated (open or closed) by the electronics and control component 130. Embodiments of the covers may include flaps or doors (as illustrated in FIGS. 1 and 2). Further embodiments of the covers are contemplated to include other mechanical sealing devices such as rotable ball valves, butterfly valves, gate valves, knife gate valve, or other mechanical sealing device as may be known in the art.

The siphoning component 110 further comprises a pump 118 located near the outlet 113 of the pipe 111 and configured to create a vacuum inside of the pipe. In embodiments, the pump 118 may also be configured to draw water up the pipe, in addition to initially creating a vacuum. The pump 118 is sealably communicative with the pipe 111 interior and operatively communicative with the electronics and control component 130. The pump 118 receives power from the electronics and control component 130. One or more flow rate sensors 121, as are known in the art, are disposed within the interior of the pipe 111. Each flow rate sensor 121 is configured to sense the rate of flow of water WF through the pipe 111 and is operatively communicative with the electronics and control component 130.

The siphoning component 110 further comprises a one or more one-way valve 119 disposed integral to the pipe 111 between the inlet 112 and the outlet 113. Each one-way valve 119 is positioned in-line to and communicative with the water flow inside the pipe 111 and is configured to prevent any backflow of water through the pipe.

The Generator Component 120

The generator component 120 is comprised of a ramp 121, or sluice, and a one or more electrical generator 122. The ramp 121 is comprised of a structure having an inclined top surface 121a, with a first end 121b higher than a second end 121c, and a support system 121d below the top surface, where the support system is configured to maintain the top surface 121a above the water level. This may be accomplished through fixed structures or buoyancy apparatus that allow the ramp to float on the water's surface. The top surface 121a of the ramp is configured to collect the water flow as it exits the pipe outlet, and direct that water flow to a one or more electrical generator 122.

In operational communication with the top surface 121a of the ramp 121, a one or more electrical generator 122 are operatively communicative with the water flow via a hydraulic turbine or water wheel. Each electrical generator is further operatively communicative with the electronics and control component.

The Electronics and Control Component

The electronics and control component comprises a one or more processor, a logic operator, and a power regulator. The electronics and control components can be realized each as one or more computing devices, executing a variety of scripts, databases, processes, and related components. One with knowledge in the art will appreciate that the components may represent all hardware components, all software components, or a combination of hardware and software components. Further embodiments of the system are configured to place the electronics and control component as a node on a local area network, or as a node accessible via a wide area network, or even the Internet.

In one embodiment, the electronics and control component comprises a physical computing device configured with network connectivity, such as Ethernet IEEE 802.3, Wireless such as IEEE 802.11, Bluetooth, ZigBee, or Cellular Wireless such as GSM. Such dedicated computing device further comprises a microprocessor device which communicates with an input/output subsystem, memory, storage and network interface. The microprocessor device is operably coupled with a communication infrastructure herein represented as a bus that is a simplified representation of the communication infrastructure required in a device of this type.

The microprocessor device may be a general or special purpose microprocessor operating under control of computer program instructions executed from memory on program data. The microprocessor may include a number of special purpose sub-processors, each sub-processor for executing particular portions of the computer program instructions. Each sub-processor may be a separate circuit able to operate substantially in parallel with the other sub-processors. Some or all of the sub-processors may be implemented as computer program processes (software) tangibly stored in a memory that perform their respective functions when executed. These may share an instruction processor, such as a general purpose integrated circuit microprocessor, or each sub-processor may have its own processor for executing instructions. Alternatively, some or all of the sub-processors may be implemented in an ASIC. RAM may be embodied in one or more memory chips.

Memory may include both volatile and persistent memory for the storage of: operational instructions for execution by Microprocessor, data registers, application storage and the like. The computer instructions/applications that are stored in memory are executed by processor. The I/O subsystem of the electronics and control component may comprise various end user interfaces such as a display, a keyboard, and a mouse. The I/O subsystem comprises a data network interface. The network interface allows software and data to be transferred between the electronics and control component and external hosts or devices. Examples of network interface can include one or a plurality of: Ethernet network interface card, wireless network interface card, network interface adapter via USB, wireless cellular modem, and the like. Data transferred via network interface are in the form of signals which may be, for example, electronic, electromagnetic, radio frequency, optical, or other signals capable of being transmitted or received by network interface.

Generally, the electronics and control component monitors, via the one or more flow sensors, the water flow through the pipe and regulates the opening and closing of the inlet and outlet covers, as well as the functioning of the pump, in order to maintain a predetermined flow of water through the electrical generator component.

In operation, the electronics and control component, upon sensing, via a flow sensor, a predetermined “low” flowrate, will close both the sealed inlet cover and the sealed outlet let cover. The electronics and control component will then power on the pump to create a vacuum within the sealed pipe. The electronics and control component would then open the inlet and the outlet. The combination of the vacuum, along with the hydrostatic pressure exerted by the water at the pipe inlet, causes the water to rush into the pipe and flow out of the pipe outlet onto the ramp. Should the flow not be sufficient to exit the pipe outlet onto the ramp, the electronics and control component can activate the pump to facilitate the flow. The one-way valve assists the efficiency of the system by preventing back flow. When a flow rate sensor detects again a “low” flow, the electronics and control component closes the covers and repeats the pumping procedure to increase the flow rate again.

The electronics and control component is powered by, and delivers electrical power to, the various sub-components such as the pump, the sensors, and the covers from a power regulator, further comprising a power source. Embodiments of the invention include a power source that is a rechargeable battery. Other embodiments contemplate the use of renewable energy generating sources such as solar panels or wind turbines connected to battery stores for the power source. Yet further embodiments contemplate that the power source may be in the form of an initially charged battery that is recharged by capturing a portion of the hydroelectric power generated by the system.

The electricity generated by the system may be transmitted to another location via power lines, or stored in batteries, or other electricity storage and transmission apparatus as may be known in the art.

It is contemplated to be within the scope and spirit of this invention that systems, as described herein, may be deployed throughout the world, wherever electrical power is needed. Embodiments of the invention may be scaled according to need, and multiple systems may be combined to generate more power.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

In light of the foregoing description, it should be recognized that embodiments in accordance with the present invention can be realized in numerous configurations contemplated to be within the scope and spirit of the claims. Additionally, the description above is intended by way of example only and is not intended to limit the present invention in any way, except as set forth in the claims presented.

The appended drawings and figures illustrate various embodiments of the present invention. It is contemplated that various other embodiments of the present invention may be within the scope of what has been disclosed herein even though it may not be shown in the embodiments depicted in the appended drawings and figures.

Therefore, while there has been described what is presently considered to be the preferred embodiment, it will be understood by those skilled in the art that other modifications can be made within the spirit of the invention. The above descriptions of embodiments are not intended to be exhaustive or limiting in scope. The embodiments, as described, were chosen in order to explain the principles of the invention, show its practical application, and enable those with ordinary skill in the art to understand how to make and use the invention. It should be understood that the invention is not limited to the embodiments described herein.

1. A system for the generation of electricity, the system comprising:
a body of water having a surface and a depth;
a siphoning component partially submerged in the body of water, the siphoning component comprising a pipe with an interior, an exterior, an inlet, an outlet, a horizontal portion at the inlet, a downward angled portion at the outlet and a vertical portion extending between the horizontal portion and the downward angled portion, a selectively removeable inlet cover sealably communicative with the inlet, a selectively removeable outlet cover sealably communicative with the outlet, a pump sealably communicative with the pipe interior and configured to create a vacuum in the pipe interior, a one or more flow-rate sensor disposed within the pipe interior and configured to sense a rate of water flow through the pipe interior, and a one or more one-way valve disposed integral to the pipe between the inlet and the outlet in-line and communicative with a water flow in the pipe interior and further configured to prevent a backflow through the pipe;
a generator component comprising a ramp and a one or more electrical generator, wherein the ramp is comprised of an inclined top surface having a first end higher than a second end and a support system fixedly attached below the top surface, wherein the support system is configured to maintain the top surface above the surface of the body of water, and wherein the one or more electrical generator is operatively communicative with the water flow via a one or more hydraulic turbine; and
an electronics and control component comprising a processor, a logic circuit, and a power regulator, wherein the electronics and control component is in electrical and operational communication with the one or more flow-rate sensor, the pump, the inlet cover, the outlet cover, and the one or more electrical generators;
whereby the system utilizes a hydrostatic pressure of the body of water at the depth of the inlet, along with the vacuum pump, to direct a water flow onto the ramp for the generation of an electrical energy.

2. The system of claim 1, further comprising a method of using the system comprising the steps of:
sensing by a flow rate sensor of a lack of a water flow through the pipe closing the inlet cover and the outlet cover;
powering of the pump by the electronics and control module;
creating a vacuum in the pipe interior by the pump;
opening of the inlet cover and outlet cover by the electronics and control module;
flowing of water through the pipe;
sensing of a water flow through the pipe by the flow rate sensor;
preventing of backflow by the one-way valve;
flowing of water onto the ramp; and
generating of electricity by the flow of water turning the power generator turbines.
